(19) United States
(12) Patent Application Publication
(10) Pub. No.: US 2019/0003018 A1
(43) Pub. Date: Jan. 3, 2019

(54) ALUMINUM ALLOY-MADE CONNECTOR FOR CONNECTING PIPING MEMBER TO HEAT EXCHANGER, PIPING MEMBER FOR CONNECTING HEAT EXCHANGER INCLUDING SAME, AND METHODS OF MANUFACTURING THESE

(71) Applicants: UACJ Extrusion Corporation, Tokyo (JP); UACJ CORPORATION, Tokyo (JP); DENSO AIR SYSTEMS CORPORATION, Anjo-shi (JP)

(72) Inventors: Satoshi WAKAGURI, Oyama (JP); Yoshiyuki OYA, Tokyo (JP); Takuya CHINO, Anjo-shi (JP)

(73) Assignees: UACJ Extrusion Corporation; UACJ CORPORATION; DENSO AIR SYSTEMS CORPORATION

(21) Appl. No.: 16/005,684

(22) Filed: Jun. 12, 2018

(30) Foreign Application Priority Data
Jun. 30, 2017 (JP) 2017-128464

(51) Int. Cl. C22C 21/10; F16L 9/02; C22F 1/05

(52) U.S. Cl. CPC C22C 21/10; F28F 21/084; C22F 1/05; F16L 9/02

(57) ABSTRACT

An aluminum alloy-made connector capable of preventing corrosion in a desired region even when being caulking-jointed to a piping member, a piping member for connecting a heat exchanger including the connector, and methods for manufacturing these are provided. The aluminum alloy-made connector is configured by an aluminum alloy extrusion material containing 0.2% to 0.8% (mass %, the same shall apply hereinafter) of Si, 0.45% to 0.9% of Mg, x_{Zn}% of Zn, and 0.001% to 0.2% of Ti, with the balance being Al and inevitable impurities. Herein, x_{Zn} satisfies {(X²+2r²)^{1/2}+34}/38≤x_{Zn}≤2.0 (when the piping member is made of an Al—Mg—Si based aluminum alloy) or {(X²+2r²)^{1/2}+16}/24≤x_{Zn}≤2.0 (when the piping member is made of an Al—Mn based aluminum alloy). Provided that, in the formula, X is the distance (mm) from the caulking jointed connector to the length-direction end portion of the region requiring corrosion prevention, and r is the radius (mm) corresponding to the external diameter of the piping member.

### CROSS-REFERENCES TO RELATED APPLICATIONS

This patent specification is based on Japanese patent application, No. 2017-128464 filed on Jun. 30, 2017 in the Japan Patent Office, the entire contents of which are incorporated by reference herein.

### BACKGROUND OF THE INVENTION

### 1. Field of the Invention

The present disclosure relates to an aluminum alloy-made connector for connecting a piping member to a heat exchanger, a piping member for connecting a heat exchanger including the same, and methods of manufacturing these.

### 2. Description of Related Art

Conventionally, aluminum alloy having sacrificial anode characteristic has been used in the connector for connecting a piping member to a heat exchanger.

For example, Patent Document 1 discloses an aluminum alloy extrusion material which is used for a connector for connecting a piping member to a heat exchanger containing 0.2 to 0.8% (mass %, the same shall apply hereinafter) of Si, 0.45% to 0.9% of Mg, 1.0% to 3.5% of Zn, 0.001 to 0.2% of Ti, with the balance being Al and inevitable impurities, and having excellent extrudability and sacrificial anode characteristic.

Further, Patent Document 2 discloses an aluminum die casting alloy for a connector containing 2% to 10% of Zn, 2% to 7% of Si as essential elements, 0.5% to 1.5% of Fe and/or 0.1% to 1.5% of Mn, with the balance being Al and inevitable impurities.

As a method of connecting the connector to the piping member, conventionally, brazing has been used. However, since brazing has high jointing reliability but high jointing cost, recently, mechanical caulking jointing has become mainstream instead of brazing in order to suppress jointing cost (Patent document 1, 2).
Patent Document 1: Japanese Patent No. 5635806
Patent Document 2: Japanese Patent Application Laid-Open No. 2007-92113

### BRIEF SUMMARY OF THE INVENTION

However, in the piping member caulking jointed with the connector, corrosion of the piping member was confirmed in the corrosion resistance test. This corrosion of the piping member was not a problem in the case where the connector and the piping member of the same material were brazed.

The corrosion of the piping member in the heat exchanger leads to the formation of through holes or cracks and may cause the leakage of the fluid flowing in the pipes, so it is necessary to avoid the corrosion.

Therefore, a problem of the present disclosure is to provide a connector made of an aluminum alloy capable of preventing corrosion in a desired region even when caulking-jointed to a piping member, a piping member for connecting a heat exchanger including the connector, and methods for manufacturing these.

The inventors of the present disclosure have investigated and examined causes of corrosion in the piping member which is caulking-jointed with connector and as a result found the following knowledge. There is a correlation between the Zn content in the aluminum alloy forming the connector and the area of the region to be prevented from corrosion by the jointing of the connector (or the distance from the connector at the place to be prevented from corrosion). The area or the distance to be prevented from corrosion is not determined by a simple distance from the connector but is determined by the distance from the place where the connector and the piping member are in contact with each other. In the case of caulking-jointing, since the contact mode between the connector and the piping member is close to point contact, the area or the distance to be prevented from corrosion becomes smaller than that of brazing. And then, based on the above knowledge, it was recognized that the above problem can be solved by optimizing the Zn content in the aluminum alloy according to the jointing position of the connector in the piping member, and the present disclosure was completed.

That is, in order to solve the above problem, the present disclosure adopts the following means.

(1) An aluminum alloy-made connector for connecting a piping member to a heat exchanger is provided. The connector is to be caulking-jointed to a piping member at a position separated by only a distance X (mm) from the length-direction end portion of the region requiring corrosion prevention in the piping member made of Al—Mg—Si-based aluminum alloy whose radius corresponding to the external diameter is r (mm). The connector is an aluminum alloy extrusion material containing 0.2 to 0.8% (mass %, the same shall apply hereinafter) of Si, 0.45% to 0.9% of Mg, x_{Zn}% of Zn, 0.001% to 0.2% of Ti, with the balance being Al and inevitable impurities, wherein x_{Zn} satisfies the following relational expression: {(X²+2r²)^{1/2}+34}/38≤x_{Zn}≤2.0.
(2) An aluminum alloy-made connector for connecting a piping member to a heat exchanger is provided. The connector is to be caulking-jointed to a piping member at a position separated by only a distance X (mm) from the length-direction end portion of the region requiring corrosion prevention in the piping member made of Al—Mn-based aluminum alloy whose radius corresponding to the external diameter is r (mm). The connector is an aluminum alloy extrusion material containing 0.2 to 0.8% (mass %, the same shall apply hereinafter) of Si, 0.45% to 0.9% of Mg, x_{Zn}% of Zn, and 0.001% to 0.2% of Ti, with the balance being Al and inevitable impurities, wherein x_{Zn} satisfies the following relational expression: {(X²+2r²)^{1/2}+16}/24≤x_{Zn}≤2.0.
(3) A piping member for connecting a heat exchanger is provided. The piping member is made of Al—Mg—Si-based aluminum alloy whose radius corresponding to the external diameter is r (mm), and has been caulking-jointed with the aluminum alloy-made connector of (1) at a position separated by only a distance X (mm) from the length-direction end portion of the region requiring corrosion prevention.
(4) A piping member for connecting a heat exchanger is provided. The piping member is made of Al—Mn-based aluminum alloy whose radius corresponding to the external diameter is r (mm), and has been caulking-jointed with the aluminum alloy-made connector of (2) at a position separated by only a distance X (mm) from the length-direction end portion of the region requiring corrosion prevention.

Incidentally, in order to solve the above-mentioned problem, it is possible to adopt a method of manufacturing the aluminum alloy-made connector described in (1) or (2), or the piping member for connecting the heat exchanger described in (3) or (4).

According to the present disclosure, by caulking-jointing to piping member for connecting heat exchanger, it is possible to provide an aluminum alloy-made connector capable of preventing the desired region of the piping member from corrosion, and a piping member for connecting heat exchanger prevented from corrosion by the caulking-jointing of the connector.

### BRIEF DESCRIPTION OF THE DRAWINGS

FIG. 1 is a schematic view of a connector according to an embodiment of the present disclosure.

FIG. 2 is a schematic view for explaining a region requiring corrosion prevention in the piping member for connecting heat exchanger.

FIGS. 3A and 3B are schematic views showing a contact mode when a connector is brazed to a piping member (FIG. 3A: a view seen from the axial direction of the piping member; FIG. 3B: a perspective view).

FIG. 4 is a schematic view showing the position relationship of the respective members when the connector is caulking-jointed to the piping member.

FIG. 5 is a schematic view showing a calculation method of an average corrosion prevention distance.

### DETAILED DESCRIPTION OF THE INVENTION

Hereinafter, an embodiment of the present disclosure (hereinafter, described as “the present embodiment”) will be described, but the present disclosure is not limited to this embodiment. In addition, estimation is included in the action mechanism described below, and its correctness does not limit the present disclosure.

Hereinafter, in the present specification, “%” refers to “mass %” unless otherwise stated.

[Composition of Aluminum Alloy for Connector]

The connector of the present embodiment is manufactured by an extrusion process of aluminum alloy. Therefore, in addition to mechanical properties such as strength and sacrificial anode characteristics, aluminum alloy as a connector material is also required to have high extrudability. The composition of the aluminum alloy in the present embodiment is specified in view of the above requirement. Hereinafter, the reason for adding and the adding amount of the component element of the aluminum alloy for the connector of the present embodiment will be described.

<About Si>

Si is an element that reacts with Mg to form Mg₂Si compound, improves the strength in the hot forming, that is, the artificial aging treatment after the extrusion molding, and forms Al—Mn—Si based or Al—Fe—Mn—Si based fine intermetallic compound together with Mn and/or Fe. The content of Si is 0.2 to 0.8%. If the content is too small, the above-described effects may be insufficient. If the content is too large, the formability at high temperature may be lowered due to excessive age hardening and the extrudability may decrease.

<About Mg>

As described above, Mg has the effect of increasing the strength in the artificial aging treatment after the extrusion molding by reacting with Si to form Mg₂Si compound, or being solid-solved in the aluminum base phase and increasing the strength by solid-solution strengthening. The content of Mg is 0.45% to 0.9%. If the content is too small, the above-described effect may be insufficient. If the content is too large, the formability at high temperature may be lowered due to excessive age hardening and the extrudability may decrease.

<About Zn>

Zn plays a particularly important role in the aluminum alloy for the connector of the present embodiment and is an element that has the effect of making the electric potential of the connector low with respect to the piping member caulking jointing the connector. The lower limit value of the Zn content is a value determined by an expression to be described later, and the upper limit value is 2.0%. By setting the Zn content in the above-mentioned range, the electric potential of the connector can be made low with respect to the Al—Mg—Si based alloy (for example, JIS6063 alloy) or the Al—Mn based alloy (for example, JIS3003 alloy or JIS3004 alloy) to be used in the piping member, and the desired region of the piping member becomes possible to be prevented from corrosion by the sacrificial anode characteristic.

If the Zn content is too small, the electric potential of the aluminum alloy extrusion material used for the connector cannot be made sufficiently low with respect to the piping member, and there is a possibility that sufficient sacrificial anode characteristic cannot be obtained. On the other hand, if the Zn content is too large, grain boundary corrosion may occur.

Incidentally, in consideration of the sacrificial anode effect, the Zn content is preferably set to 1.5% or more.

<About Ti>

Ti has an effect of refining the ingot structure of the aluminum alloy, and at the same time has the function of improving the strength by solid-solution strengthening and improving the corrosion resistance. The content of Ti is 0.001% to 0.2%, preferably 0.01% to 0.05%. If the content is too small, the above-described effect may be insufficient. If the content is too large, the processability may be deteriorated due to the formation of coarse intermetallic compound.

<Inevitable Impurities>

The inevitable impurities are mixed from various routes such as the base metal, additive element alloys during casting the aluminum alloy. In particular, Fe is the element most contained in the aluminum base metal. When the Fe exceeds 0.35%, Al—Fe—Si based crystallized product is formed at the time of casting, and the processability may be deteriorated. Therefore, the content of Fe is set to 0.35% or less. Other inevitable impurities may be contained since the influence on the alloy characteristics is small as long as the content is 0.05% or less as a single substance and 0.15% or less in total.

[Shape of Connector]

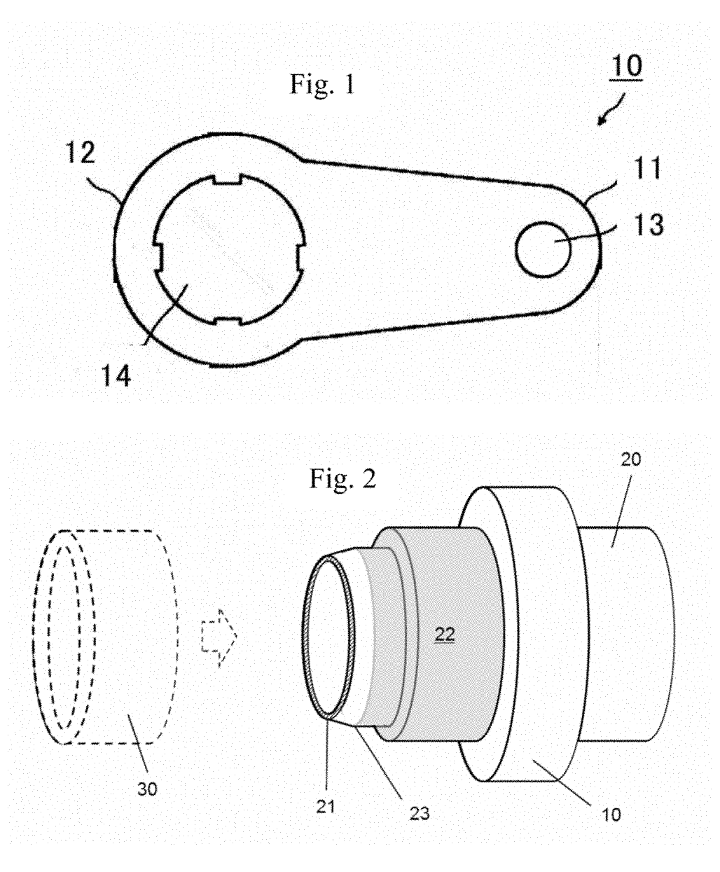

As shown in FIG. 1, the connector 10 in the present embodiment has a shape of Keyhole-Shaped Tumulus. The square portion 11 is formed with a first through-hole 13 for inserting a bolt as fixing means, and the circular portion 12 is formed with a second through-hole 14 for inserting a predetermined piping member. Incidentally, in FIG. 1, as the shape of the second through-hole 14, a shape in which two pairs of convex portions are formed to face each other on the inner wall is shown, but the shape of the second through-hole is not limited thereto and may be a shape without convex portions.

[Manufacturing Method of Connector]

The connector having the above-mentioned shape can be manufactured by the following method.

<Melting, Casting, Homogenizing Heat Treatment>

The molten aluminum alloy which has been melted and adjusted within the above-described composition range is cast by appropriately selecting an ordinary melt casting method of continuous casting/rolling method, semi-continuous casting method (DC casting method) or the like. Subsequently, the cast Al alloy ingot is subject to a homogenizing heat treatment. As the temperature of the homogenizing heat treatment, a temperature of 500° C. or higher and lower than the melting point is appropriately selected as usual.

<Solution Treatment and/or Quenching Treatment>

In the present embodiment, a solution treatment and/or a quenching treatment can be performed as necessary. By performing a solution treatment and/or a quenching treatment, a coarse Mg₂Si intermetallic compound can be solid-solved sufficiently. If the coarse Mg₂Si intermetallic compound is not solid-solved after the solution treatment, it will cause a decrease in the strength after the artificial aging treatment. The solution treatment is preferably performed in a temperature range of 500° C. to 560° C.

In the quenching treatment following the solution treatment, when the cooling speed is slow, Si, Mg₂Si and the like become likely to be precipitated on the grain boundary. The grain boundary precipitates tend to become the starting points of cracks during molding and cause molding defectives. In order to ensure a high cooling speed, in the quenching treatment, it is preferable to adopt air cooling using a fan or the like, or water cooling by mist, spray or dipping or the like, and set the cooling speed as 10° C./second or faster.

<Extrusion Process>

After the Al alloy ingot is obtained as described above, the ingot is subjected to an extrusion process to obtain an extruded material (connector in the present embodiment) having the intended shape and size. The extrusion process on the Al alloy ingot can be performed by using a method such as a port hole method or a mandrel method or the like.

[Piping Member]

As a piping member to be jointed with the connector, a member made of an aluminum alloy such as an Al—Mg—Si based alloy or an Al—Mn based alloy is suitably used. Among the Al—Mg—Si based alloy, the JIS6063 alloy (containing 0.20% to 0.6% of Si, 0.35% or less of Fe, 0.10% or less of Cu, 0.10% or less of Mn, 0.45% to 0.9% of Mg, 0.10% or less of Cr, 0.10% or less of Zn, 0.10% or less of Ti, with a balance being Al and inevitable impurities) is more preferable. Among the Al—Mn based alloy, the JIS3003 alloy (containing 0.6% or less of Si, 0.7% or less of Fe, 0.05% to 0.20% of Cu, 1.0% to 1.5% of Mn, 0.10% or less of Zn, with a balance being Al and inevitable impurities) or the JIS3004 alloy (containing 0.30% or less of Si, 0.7% or less of Fe, 0.25% or less of Cu, 1.0% to 1.5% of Mn, 0.8% to 1.3% of Mg, 0.25% or less of Zn, with a balance being Al and inevitable impurities) is more preferable.

The shape and size of the piping member may be appropriately set according to the design of the heat exchanger.

As described above, corrosion should be avoided for the piping member. Particularly, in the vicinity of the portion to be connected to other member, since there is a place where stress is applied by contact with the other member, it is necessary to avoid corrosion.

In the present embodiment, a place where corrosion should be particularly avoided in the piping member, is referred to as a region requiring corrosion prevention. Specifically, as shown in FIG. 2, the region requiring corrosion prevention is a region 22 (colored portion in the figure) from the joining place of the connector 10 to the place in contact with other member 30 which is located on the side of the end portion 21. In addition, the length-direction end portion of the region requiring corrosion prevention means the end portion 23 (see FIG. 2) on the side opposite to the connector 10 (the side of the other member 30) in the region requiring corrosion prevention.

[Jointing Method of Connector and Piping Member]

When the connector 10 shown in FIG. 1 is caulking jointed to the piping member, after the piping member is inserted to the second through-hole 14 to a predetermined position, the connector 10 is fixed to the piping member by caulking.

[Relationship between Zn Content in Aluminum Alloy and Corrosion Preventable Distance]

Conventionally, whether or not a piping member can be prevented from corrosion was considered as follows. That is, it is a matter determined only by the potential difference between the connector and the piping member, in other words, the materials of the two, and if the materials of the two are decided to make the potential of the connector low with respect to the piping member to some extent, the entire necessary region can be prevented from corrosion merely by jointing the connector to the piping member regardless of the jointing method.

However, as described above, it was confirmed that even when a connector and a piping member of the same material were used, corrosion did not occur in jointing by brazing, and corrosion may occur in the caulking-jointing.

The inventors of the present disclosure investigated and examined the relationship between the aluminum alloy composition of the connector and the presence or absence of corrosion in the piping member caulking-jointed with the connector during investigating the cause of the occurrence of corrosion in the caulking-joint, and found out that in the piping member jointed with the connector which is manufactured by an aluminum alloy with relatively small Zn content, corrosion occurs at a position separated from the connector, and as the Zn content decreases, corrosion occurs at a position closer to the connector. From this fact, it is presumed that the connector has sacrificial anode characteristic and the distance is limited, and the distance is positively correlated with the Zn content of the aluminum alloy forming the connector.

By further detailed investigation, after comparing the presence or absence of corrosion at a plurality of places having equal distances in the length direction from the connector, no corrosion was confirmed at the position close to the contact place between the connector and the piping member, and corrosion was seen at the position separated from the contact place. From this fact, it is presumed that the region capable of being prevented from corrosion by jointing the connector is determined not by the simple distance from the connector but by the distance from the place where the connector and the piping member are in contact.

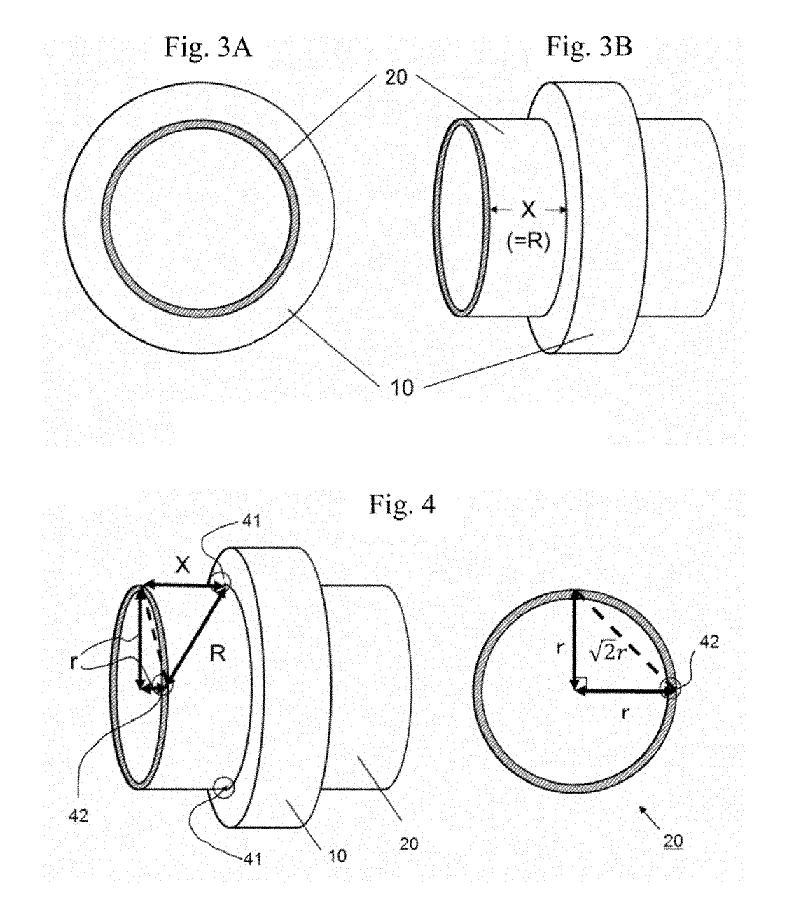

As in the prior art, when the connector is brazed to the piping member, as shown in FIG. 3A, the connector 10 and the piping member 20 are in contact with each other over the entire circumference of the piping member 20. In this case, the shortest distance R that passes the surface of the piping member 20 from an arbitrary point located on the outer peripheral surface of the piping member 20 to the contact place between the connector 10 and the piping member 20, is always coincident with the shortest distance X (FIG. 3B) from the arbitrary point to the connector 10. Therefore, as long as the shortest distance X from the place to be prevented from corrosion to the connector 10 is set to be equal to or shorter than the distance where the sacrificial anode characteristic of the connector 10 is reached (hereinafter, referred to as “corrosion preventable distance”), the place is prevented from corrosion. Then, in the piping member 20, in order to exert the sacrificial anode characteristic over the entire region requiring corrosion prevention, the connector 10 may be just jointed at a position where the shortest distance X from the length-direction end portion of the region to the connector 10 is equal to or shorter than the corrosion preventable distance.

On the other hand, when the connector is caulking jointed to the piping member as in this embodiment, as shown in FIG. 4, the connector 10 and the piping member 20 are in contact with each other only at a portion of the second through-hole 14 of the connector 10 (in the figure, the contact portion is set to 41). In this case, the shortest distance R that passes the surface of the piping member 20 from an arbitrary point located on the outer peripheral surface of the piping member 20 to the contact place between the connector 10 and the piping member 20, may become longer than the shortest distance X from the arbitrary point to the connector 10. Therefore, even when the shortest distance X from the place to be prevented from corrosion to the connector 10 is set to be equal to or shorter than the corrosion preventable distance, in the case where the shortest distance R that passes the surface of piping member 20 to the contact place between the connector 10 and the piping member 20 is longer than the corrosion preventable distance, the place cannot be prevented from corrosion, and corrosion will occur. Then, in the piping member 20, in order to exert the sacrificial anode characteristic over the entire region requiring corrosion prevention, it is necessary to joint the connector 10 at a position where the shortest distance R that passes the surface of the piping member 20 from every point located on the length-direction end portion of the region to the contact place 41 between the connector 10 and the piping member 20 is equal to or shorter than all the corrosion preventable distance.

[Optimization of Zn Content in Aluminum Alloy]

As described above, it is technically possible to optimize the jointing position of the connector in order to prevent corrosion in the desired region of the piping member. However, in many cases, the jointing position of the connector and the region requiring corrosion prevention are determined in advance in the piping member for connecting heat exchanger. Accordingly, in order to prevent corrosion in the desired region of the piping member in such a case, a method of optimizing the Zn content in the aluminum alloy forming the connector will be described based on the above knowledge.

In case of caulking-jointing the connector to the piping member, as shown in FIG. 4, at least the connector 10 and the piping member 20 need to be in contact with each other at two points facing each other. This contact mode is the most disadvantageous in terms of corrosion prevention of the piping member 20. Therefore, in this contact mode, among the places where the shortest distances X from the connector 10 are equal to each other, it is considered to prevent corrosion at the place 42 where the shortest distance R that passes the surface of the piping member 20 from the contact place 41 between the connector 10 and the piping member 20 is the longest.

Assuming that a radius corresponding to the external diameter of the piping member 20 is r (mm), the shortest distance from the connector 10 to the place 42 to be prevented from corrosion is X (mm), the shortest distance that passes the surface of the piping member 20 from the contact place 41 to the place 42 to be prevented from corrosion is R (mm), and this R is a linear distance, according to the Pythagoras' theorem, the R can be approximately expressed as the following (expression 1).

R=(X²+2r²)^{1/2} (expression 1)

On the other hand, assuming that the corrosion preventable distance y (mm) of the connector 10 is proportional to the Zn content x_{Zn} in the aluminum alloy, this corrosion preventable distance y can be expressed as the following (expression 2).

y=ax_{Zn}+b(provided that a and b are constants) (expression 2)

Here, the constants a and b can be calculated by the following method.

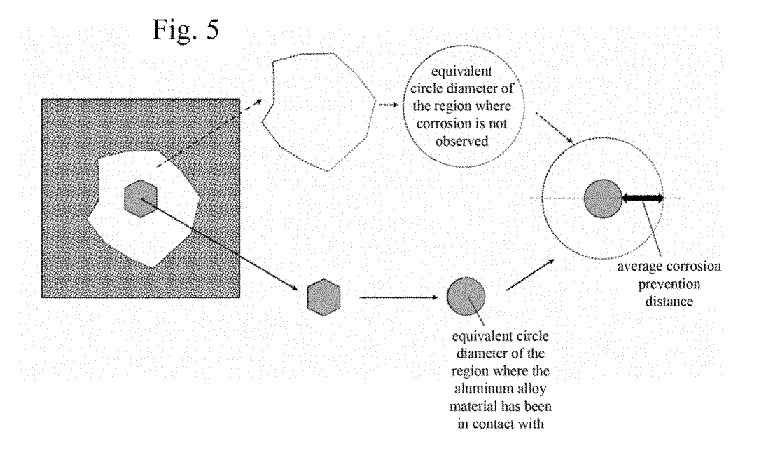

A plurality of aluminum alloy materials for connectors having different Zn contents x_{Zn} are prepared, placed in the center of a plate having the same composition as the piping member and having an area sufficiently larger than the alloy materials and subjected to the CASS test. After the test, the area of the region where corrosion is not observed is measured by image processing or the like, and the radius of the circle having this area (equivalent circle diameter) is calculated. Also, with the same method, the area where the aluminum alloy material for connector has been in contact with the plate is measured, and the radius of the circle having this area (equivalent circle diameter) is calculated. Then, the difference of each equivalent circle diameter is calculated as the average corrosion prevention distance (see FIG. 5). The calculated average corrosion prevention distance is plotted against the Zn content in the alloy material, and the inclination and the intercept of the approximate straight line are obtained by the least-squares method, thereby constants a and b are calculated.

In order to prevent corrosion, the shortest distance R that passes the surface of the piping member 20 from the contact place 41 to the place 42 to be prevented from corrosion needs to be equal to or shorter than the corrosion preventable distance y. Therefore, from the (expression 1) and (expression 2), the following (expression 3) will be satisfied.

(X²+2r²)^{1/2}≤ax_{Zn}+b (expression 3)

This expression is modified, and the Zn content x_{Zn} in the aluminum alloy for preventing corrosion at the place at the distance X from the connector 10 is determined as the following (expression 4).

x_{Zn}≥{(X²+2r²)^{1/2}−b}/a (expression 4)

According to the above mentioned method, by determining the Zn content of the aluminum alloy forming the connector 10, it is possible to exert sacrificial anode characteristic over the entire region requiring corrosion prevention without changing the jointing position of the connector 10.

### EXAMPLES

Hereinafter, the present embodiment will be described more specifically by way of Examples. It is to be noted that the Examples are merely an illustration for explaining the effect of the present embodiment, and the technical scope of the present disclosure including the present embodiment is not limited to the Examples.

[Determination of Constants a and b for JIS6063 Alloy]

### Reference Examples 1 to 3

Alloys having the composition shown in Table 1 were prepared by the semi-continuous casting method and then homogenized at 565° C. for 4 hours. This billet was heated to 500° C. and extruded by a porthole extrusion at an extrusion speed of 5 m/min to produce a connector 10 having the shape shown in FIG. 1.

TABLE 1

| | Si (%) | Mg (%) | Zn (%) | Ti (%) | Fe (%) | Al |
|---|---|---|---|---|---|---|
| Reference | 0.47 | 0.52 | 1.0 | 0.01 | 0.2 | Balance |
| Example 1 | | | | | | |
| Reference | 0.49 | 0.55 | 1.5 | 0.01 | 0.15 | Balance |
| Example 2 | | | | | | |
| Reference | 0.49 | 0.55 | 2.0 | 0.01 | 0.16 | Balance |
| Example 3 | | | | | | |

Each of the connectors was fixed to a plate (100 mm×100 mm×2 mm) made of JIS6063 alloy with a resin-made screw to be used as a test specimen, and this test specimen was subjected to a 300-hour CASS test. After the completion of the test, the average corrosion prevention distance of each test specimen was calculated by the above mentioned method. The constants a and b of the above (expression 4) were calculated from the relationship between the average corrosion prevention distance and the Zn content of the connector alloy, and a=38, b=−34 were obtained.

[Determination of Constants a and b for JIS3004 Alloy] (Reference Examples 4 to 6) The constants a and b were calculated in the same manner as in Reference Examples 1 to 3, except that the alloy plate for fixing the connector was made of JIS3004 alloy. As a result, a=24 and b=−16 were obtained.

[Confirmation of Corrosion Preventable Distance]

### Examples 1, 2

Each of the connectors manufactured in Reference Examples 2, 3 was caulking-jointed at a position where the distance from the end portion of the piping member (external diameter of 20 mm) made of JIS6063 alloy was 10 mm to be used as a test specimen, and this test specimen was subjected to a 300-hour CASS test. After the completion of the test, each test specimen was visually observed, and no occurrence of corrosion in the piping member was confirmed.

### Comparative Example 1

A test specimen according to Comparative Example 1 was manufactured and a corrosion resistance test was performed in the same manner as in Example 1, except that the connector manufactured in the above Reference Example 1 was used. After the completion of the test, the test specimen was visually observed, and corrosion was confirmed at the end portion of the piping member.

In Examples 1, 2 and Comparative Example 1, the Zn content in the connector necessary for the corrosion prevention of the end portion of the piping member is calculated to be about 1.4% from the values of the constants a and b calculated according to the above (expression 4) and the above Reference Examples 1 to 3. Therefore, corrosion of the piping member was not confirmed in Examples 1, 2 using a connector with a Zn content larger than this, whereas in Comparative Example 1 using a connector with a Zn content smaller than this, it is impossible to prevent corrosion to the end portion of the piping member, and it is understood that corrosion occurred.

### Examples 3, 4

The test specimens according to Examples 3, 4 were manufactured and the corrosion resistance test was performed in the same manner as in Examples 1, 2, except that a piping member made of JIS3004 alloy was used. After the completion of the test, the test specimens were visually observed, and occurrence of corrosion was confirmed in the piping member.

### Comparative Example 2

A test specimen according to Comparative Example 2 was manufactured and a corrosion resistance test was performed in the same manner as in Example 3, except that the connector manufactured in the above Reference Example 1 was used. After the completion of the test, the test specimen was visually observed, and corrosion was confirmed at the end portion of the piping member.

In Examples 3, 4 and Comparative Example 2, the Zn content in the connector necessary for the corrosion prevention of the end portion of the piping member is calculated to be about 1.4% from the values of the constants a and b calculated according to the above (expression 4) and the above Reference Examples 4 to 6. Therefore, corrosion of the piping member was not confirmed in Examples 3, 4 using a connector with a Zn content larger than this, whereas in Comparative Example 2 using a connector with a Zn content smaller than this, it is impossible to prevent corrosion to the end portion of the piping member, and it is understood that corrosion occurred.

### INDUSTRIAL APPLICABILITY

According to the present disclosure, when a connector is jointed to a piping member for connecting heat exchanger, even caulking jointing having a low jointing cost is adopted, a desired region of the piping member can be prevented from corrosion without changing the jointing position of the connector, which is useful in that the reliability can be improved while reducing the manufacturing cost of the piping member for connecting heat exchanger.

### DESCRIPTION OF SYMBOLS

10 connector
11 square portion
12 circular portion
13 first through-hole
14 second through-hole
20 piping member
21 end portion
30 other member

What is claimed is:

1. An aluminum alloy-made connector for connecting a piping member to a heat exchanger, wherein
with respect to a piping member made of an Al—Mg—Si based aluminum alloy having a radius of r (mm) corresponding to an external diameter, the connector is caulking-jointed at a position separated only by a distance X (mm) from a length-direction end portion of a region requiring corrosion prevention in the piping member,
the connector is an aluminum alloy extrusion material comprising 0.2% to 0.8% (mass %, the same shall apply hereinafter) of Si, 0.45% to 0.9% of Mg, x_{Zn}% of Zn, and 0.001 to 0.2% of Ti, with a balance being Al and inevitable impurities,
the x_{Zn} satisfies the following relational expression:
{(X²+2r²)^{1/2}+34}/38≤x_{Zn}≤2.0.

2. An aluminum alloy-made connector for connecting a piping member to a heat exchanger, wherein
with respect to a piping member made of an Al—Mn based aluminum alloy having a radius of r (mm) corresponding to an external diameter, the connector is caulking-jointed at a position separated only by a distance X (mm) from a length-direction end portion of a region requiring corrosion prevention in the piping member,
the connector is an aluminum alloy extrusion material comprising 0.2% to 0.8% (mass %, the same shall apply hereinafter) of Si, 0.45% to 0.9% of Mg, x_{Zn}% of Zn, and 0.001% to 0.2% of Ti, with a balance being Al and inevitable impurities,
the x_{Zn} satisfies the following relational expression:
{(X²+2r²)^{1/2}+16}/24≤x_{Zn}≤2.0.

3. A piping member for connecting a heat exchanger, wherein
the piping member is made of an Al—Mg—Si based aluminum alloy having a radius of r (mm) corresponding to an external diameter,
the aluminum alloy-made connector described in claim 1 is caulking-jointed at a position separated only by a distance X (mm) from a length-direction end portion of a region requiring corrosion prevention.

4. A piping member for connecting a heat exchanger, wherein
the piping member is made of an Al—Mn based aluminum alloy having a radius of r (mm) corresponding to an external diameter,
the aluminum alloy-made connector described in claim 2 is caulking-jointed at a position separated only by a distance X (mm) from a length-direction end portion of a region requiring corrosion prevention.
